(19) United States
(12) Patent Application Publication
(10) Pub. No.: US 2006/0121255 A1
(43) Pub. Date: Jun. 8, 2006

(54) Parallel multilayer printed circuit board having interlayer conductivity due to via ports and method of fabricating same

(75) Inventors: Chang Hyun Nam, Chungcheongbuk-do (KR); Seung Chul Kim, Chungchengbuk-do (KR); Seok Hwan Ahn, Kyunggi-Do (KR)

Correspondence Address: DARBY & DARBY P.C., P. O. BOX 5257, NEW YORK, NY, 10150-5257, US

(73) Assignee: Samsung Electro-Mechanics Co., Ltd., Kyunggi-do (KR)

(21) Appl. No.: 11/085,888

(22) Filed: Mar. 21, 2005

(30) Foreign Application Priority Data
Dec. 6, 2004 (KR) 10-2004-0101894

(51) Int. Cl. C25D 5/02; B32B 3/00; C23C 26/00; B32B 18/00; C25D 3/38

(52) U.S. Cl. 428/209; 428/210; 427/96.1; 205/126; 205/291

(57) ABSTRACT

Disclosed is a parallel multilayer printed circuit board (MLB), in which conductivity is provided to a through hole, formed through an interlayer connection layer, using a pair of via posts formed on circuit layers, and a method of fabricating the same. The parallel MLB comprises insulating layers through which a plurality of through holes is formed. A pair of circuit layers is laminated on the insulating layers. The via posts, made of a conductive material, protrude from the circuit layers such that the via posts correspond in position to the through holes of the insulating layers, and are in contact with each other to provide interlayer connection.

### INCORPORATION BY REFERENCE

The present application claims priority under 35 U.S.C. §119 to Korean Patent Application No. 10-2004-0101894 filed on Dec. 6, 2004. The content of the application is incorporated herein by reference in its entirety.

### BACKGROUND OF THE INVENTION

1. Field of the invention

The present invention relates, in general, to a parallel multilayer printed circuit board (MLB) and a method of fabricating the same and, more particularly, to a parallel MLB, in which conductivity is provided to a through hole, formed through an interlayer connection layer, using a pair of via posts formed on circuit layers, and a method of fabricating the same.

2. Description of the Prior Art

In accordance with the trend toward small, slim, highly integrated, packaged, and portable electronic goods, realization of a micro-patterned, small-sized, and packaged MLB is in progress.

Accordingly, substances for constituting the MLB are being replaced and the number of layers constituting the MLB is increasing so as to form a micro pattern on the MLB, to assure reliability of the MLB, and to increase the design density of the MLB. As for electronic parts, a dual in-line package (DIP) type of electronic part is apt to be replaced by a surface mount technology (SMT) type of electronic part, so the mounting density of electronic parts gradually increases.

Furthermore, there remains a need for a sophisticated technology for designing a complicated PCB (printed circuit board) because it is needed for recent portable and multi-purpose electronic goods to function to transceive moving pictures and large amounts of data on-line.

A power circuit, a ground circuit, a signal circuit and the like are constructed on the internal layers of the MLB, and the prepreg is interposed between the internal and external layers, or between the external layers to realize isolation and attachment. At this time, the wires on each layer are connected to each other through via holes (through holes).

Conventionally, a so-called serial build-up process, in which connection and circuit layers are sequentially laminated on a double-sided PCB, has been employed. However, recently, a so-called parallel or package lamination process, in which the desired number of connection and circuit layers are separately formed and are then pressed at the same time, has been suggested.

FIGS. 1a to 4 illustrate a method of fabricating a conventional parallel MLB.

FIGS. 1a to 1d are sectional views illustrating the fabrication of a circuit layer in the method of fabricating the conventional parallel MLB.

FIG. 1a illustrates a typical copper clad laminate 101 in which copper foils 102 are layered on both sides of an insulating layer 103.

In FIG. 1b, a fine through hole 104 is formed through the copper clad laminate. The through hole is formed using a YAG or CO₂ laser, or through a mechanical drilling process so as to have a diameter of 50-100 μm.

In FIG. 1c, the copper clad laminate, through which the through hole is formed, is subjected to electroless and electrolytic plating processes to plate upper and lower sides thereof and a wall of the through hole. As shown in FIG. 1c, plating layers 105 are formed on the upper and lower sides of the copper clad laminate and on the wall of the through hole, and the fine through hole 104 is packed by the plating layers 105 without using an additional plugging process.

In addition to the packing of the through hole 104 by the plating as described above, after the plating of the wall by the electroless and electrolytic plating processes, an insulating ink may be packed in the remaining space of the through hole. Alternatively, a conductive ink may be packed in the through hole without using the electroless and electrolytic plating processes.

In FIG. 1d, a circuit pattern is formed through a circuit pattern formation process, such as etching. A circuit layer 106 thus formed may be used as a circuit layer in a method of fabricating a parallel PCB.

FIGS. 2a to 2d are sectional views illustrating the fabrication of a connection layer, which constitutes a conventional parallel MLB, in a method of fabricating the conventional parallel MLB.

FIG. 2a illustrates a slat-type insulator 201 in which release films 202 are attached to both sides of a prepreg 203. The thickness of the prepreg depends on the specification of the product, and each of the release films is 20-30 μm in thickness. The release films may be attached to the prepreg during the fabrication of the prepreg, or after the fabrication of the prepreg.

In FIG. 2b, the slat-type insulator 201 is drilled to form through holes 204 therethrough. At this stage, it is preferable to form the through holes using a mechanical drilling process.

In FIG. 2c, a paste 205 is packed in the through holes 204, and the release films 202 are removed in FIG. 2d.

A circuit layer 206b, which is fabricated through the above procedure, is used as a connection layer in the method of fabricating the parallel PCB.

The single-layered insulator, on which the release films are laminated, as shown in FIG. 2a may be used as the connection layer. Alternatively, a structure, in which thermosetting resins in a semi-cured stage (b-stage) are laminated on both sides of another thermosetting resin in a completely cured stage (c-stage) and release films are attached thereto, may be used instead of the insulator.

In FIG. 3, the predetermined number of circuit layers 106a, 106b, 106c, which are formed through the procedure of FIGS. 1a to 1d, and the predetermined number of connection layers 206a, 206b, which are formed through the procedure of FIGS. 2a to 2d, are alternately arranged.

The layers are aligned in a targeting or pin manner so that connection parts 107 of the circuit layers exactly match with connection parts 207 of the insulating layers.

Subsequently, the circuit and connection layers are pressed using a press in the direction of the arrow in FIG. 3, thereby creating a six-layered PCB as shown in FIG. 4.

With reference to FIGS. 3 and 4, the connection parts 107 of the circuit layers are formed by packing using an electrolytic plating process, and made of copper. The connection parts 207 of the connection layers are formed by the packing of a conductive ink. Therefore, when the connection parts 107 of the circuit layers come into contact with the connection parts 207 of the connection layers, a portion 401 of each connection part 207 of the connection layer is squeezed by each connection part 107 of the circuit layers due to a difference in hardness. In other words, in the method of fabricating the conventional MLB, the connection parts 107 of the circuit layers are formed so as to have a wide contact area, thus being connected to the connection parts 207 of the connection layers while covering the connection parts 207.

Meanwhile, a typical diameter of a via hole, which is formed through the connection layer fabricated according to a conventional technology, is about 100 μm or more. Therefore, the diameter of each of the connection parts of the circuit layers is about 250 μm, and the diameter of the portion of a circuit pattern that is not connected to the connection part of the connection layer is limited to about 50 μm or less. Additionally, it is impossible to reduce an interval between the via holes, hindering assurance of a high density circuit.

### SUMMARY OF THE INVENTION

Therefore, the present invention has been made keeping in mind the above disadvantages occurring in the prior arts, and an object of the present invention is to provide a parallel MLB, in which a through hole for providing interlayer connection through a connection layer is very small, and a method of fabricating the same.

Another object of the present invention is to provide a parallel MLB, which can cope with an interlayer registration problem and reduce fabrication time and cost, and a method of fabricating the same.

The above objects can be accomplished by providing a parallel MLB, which has interlayer conductivity due to via posts. The parallel MLB comprises insulating layers through which a plurality of through holes are formed; and a pair of circuit layers which are laminated on both sides of the insulating layers, and which have the via posts, made of a conductive material, protruding therefrom. The via posts are formed at positions corresponding to the through holes of the insulating layers such that the via posts come into contact with each other to provide interlayer connection.

Furthermore, the present invention provides a method of fabricating a parallel MLB having interlayer conductivity due to via posts. The method comprises a step of forming a plurality of through holes through an insulating layer; another step of forming circuit layers on both sides of each of a pair of base substrates; a step of forming via posts on the circuit layers of the pair of base substrates such that the via posts correspond in position to the through holes of the insulating layer, in which the circuit layers are to be laminated on the insulating layer to come into contact therewith; and a step of aligning the pair of base substrates in such a way that the insulating layer is interposed between the base substrates so that the via posts are positioned in the through holes of the insulating layer, and heating and pressing a resulting structure to cause the via posts, facing each other, to come into contact with each other.

### BRIEF DESCRIPTION OF THE DRAWINGS

The above and other objects, features and other advantages of the present invention will be more clearly understood from the following detailed description taken in conjunction with the accompanying drawings, in which:

FIGS. 1a to 1d are sectional views illustrating the fabrication of a circuit layer in a method of fabricating a parallel MLB according to the conventional technology;

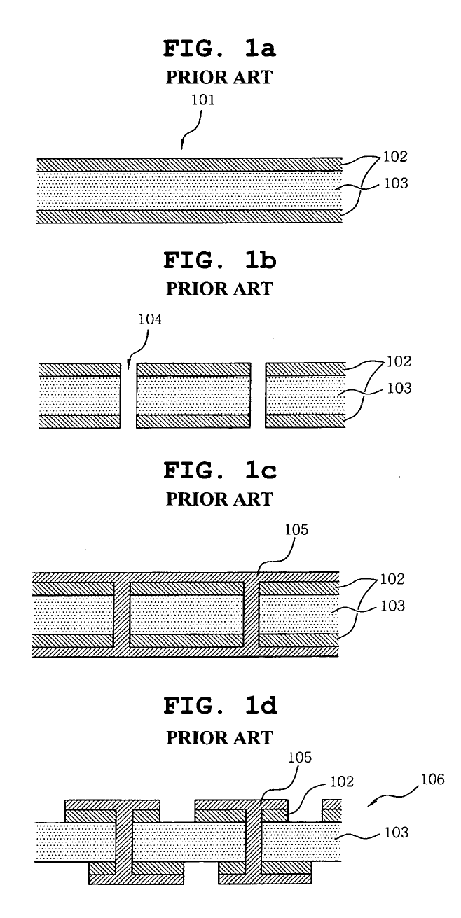

FIGS. 2a to 2d are sectional views illustrating the fabrication of a connection layer in the method of fabricating the parallel MLB according to the conventional technology;

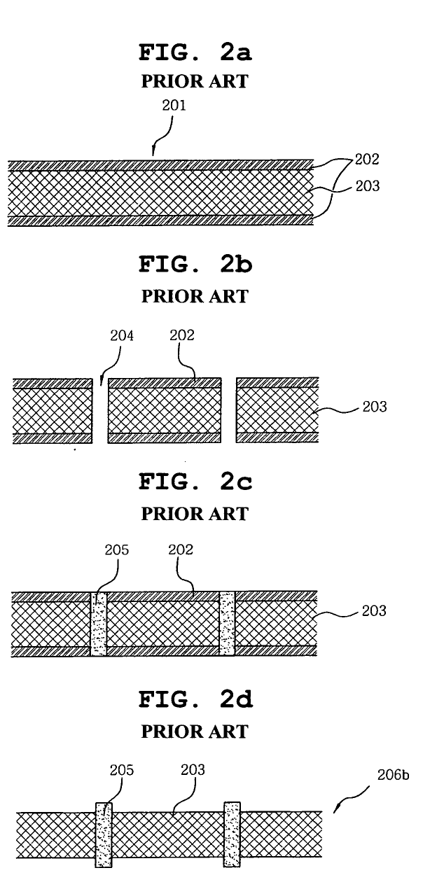

FIG. 3 illustrates alternate arrangement of the circuit layer and the connection layer in the method of fabricating the parallel MLB according to the conventional technology;

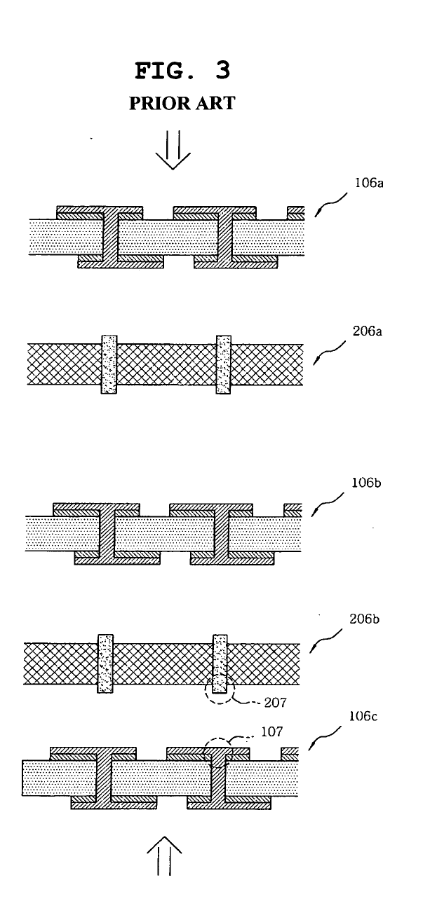

FIG. 4 is a sectional view of the parallel MLB which is fabricated by pressing the layers of FIG. 3;

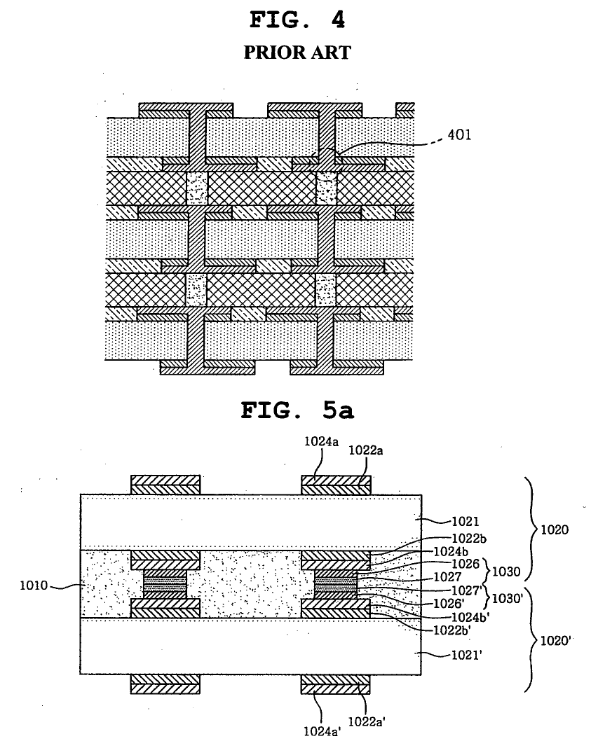

FIGS. 5a, 5b, and 5c are sectional views of parallel MLBs according to multiple embodiments of the present invention;

FIGS. 6a to 6h are sectional views illustrating the fabrication of a circuit layer through a semi-additive process in a method of fabricating the parallel MLB according to an embodiment of the present invention;

FIGS. 7a to 7c are sectional views illustrating the fabrication of a connection layer in the method of fabricating the parallel MLB according to an embodiment of the present invention;

FIG. 8 illustrates the alternate arrangement of the circuit layer and the connection layer in the method of fabricating the parallel MLB according to an embodiment of the present invention;

FIG. 9 is a sectional view of the MLB according to an embodiment of the present invention, which is fabricated by pressing the layers of FIG. 8 together;

FIGS. 10a to 10f are sectional views illustrating the fabrication of a circuit layer through a full-additive process in a method of fabricating a parallel MLB according to another embodiment of the present invention;

FIG. 11 illustrates the alternate arrangement of the circuit layer and a connection layer in the method of fabricating the parallel MLB according to the embodiment in FIG. 10 of the present invention; and

FIG. 12 is a sectional view of the MLB according to the embodiment in FIG. 10 of the present invention, which is fabricated by pressing the layers of FIG. 11.

### DETAILED DESCRIPTION OF THE INVENTION

Hereinafter, a detailed description will be given of the present invention with reference to the drawings.

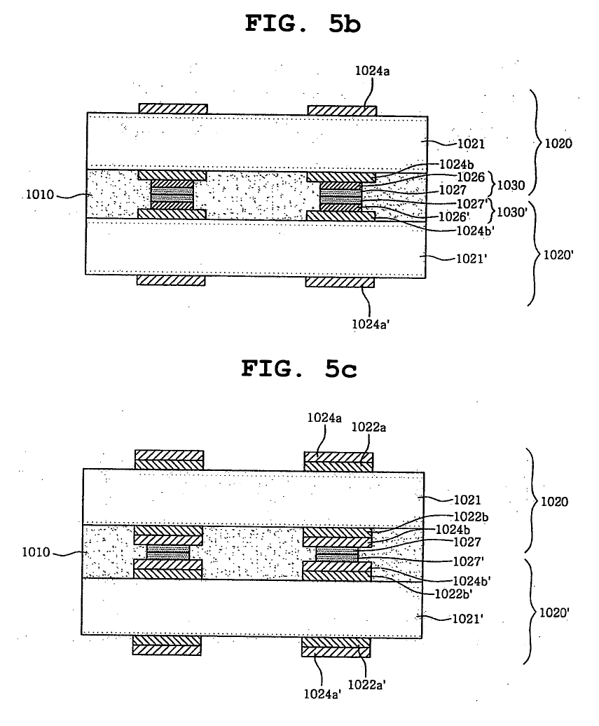

FIG. 5a is a sectional view of a parallel MLB according to an embodiment of the present invention.

With reference to FIG. 5a, the parallel MLB according to an embodiment of the present invention is provided with an internal layer 1010, and external layers 1020, 1020′ on both sides of the internal layer 1010.

In this regard, the internal layer 1010 is a connection layer for physically connecting the external layers 1020, 1020′ to each other, and may consist of a prepreg. The thickness of the prepreg depends on the specification of the product.

Furthermore, a plurality of through holes is formed through the connection layer 1010, that is, the internal layer, to electrically connect the external layers 1020, 1020′ to each other.

Additionally, the upper external layer 1020 consists of an insulating layer 1021, and circuit layers 1022a, 1024a, 1022b, 1024b (reference numerals 1022a and 1022b denote electroless copper plating layers, and reference numerals 1024a and 1024b denote electrolytic copper plating layers) formed on both sides of the insulating layer 1021. In addition, the lower external layer 1020′ consists of an insulating layer 1021′, and circuit layers 1022a′, 1024a′, 1022b′, 1024b′ (reference numerals 1022a′ and 1022b′ denote electroless copper plating layers, and reference numerals 1024a′ and 1024b′ denote electrolytic copper plating layers) formed on both sides of the insulating layer 1021′.

In the circuit layers 1022b, 1024b of the upper external layer 1020, which are in contact with the connection layer 1010, via posts 1030 are formed on portions of circuit patterns, which have positions corresponding to the through holes of the internal layer 1010.

As well, in the circuit layers 1022b′, 1024b′ of the lower external layer 1020′, which are in contact with the connection layer 1010, via posts 1030′ are formed on portions of circuit patterns, which have positions corresponding to the through holes of the internal layer 1010.

The via posts 1030, which are formed on the lower circuit layers 1022b, 1024b of the upper external layer 1020, and the via posts 1030′, which are formed on the upper circuit layers 1022b′, 1024b′ of the lower external layer 1020′, are electrically connected to each other through the through holes of the connection layer 1010, thereby providing interlayer conductivity to the connection layer 1010.

Meanwhile, a pair of via posts 1030, 1030′ protrudes from the circuit patterns of the circuit layers 1022b and 1024b, and 1022b′ and 1024b′, which correspond in position to the through holes of the internal layer 1010. The via posts 1030, 1030′ consist of connection parts 1027, 1027′ and support parts 1026, 1026′.

The connection parts 1027, 1027′ are connected to each other to act as layers for providing electric connection, and it is preferable that they be made of Sn. When using Sn, the connection parts have a melting point that is higher than that of the prepreg, thus the prepreg is melted during the connection process, and packed in the through holes of the connection layer 1010.

The support parts 1026, 1026′ are layers for supporting the connection parts 1027, 1027′, and may be made of Cu, Ag, or Au.

FIG. 5b is a sectional view of a parallel MLB according to another embodiment of the present invention, which is different from the previous embodiment of FIG. 5a in that each of circuit layers 1024a, 1024a′ consists of a single layer, in other words, only an electroless copper plating layer.

FIG. 5c is a sectional view of a parallel MLB according to yet another embodiment of the present invention, which is different from the previous embodiment of FIG. 5a in that each of the via posts 1030, 1030′ consists of a single layer.

In this case, the via posts 1030, 1030′ may be made of Sn, or a paste containing Sn, Cu, Ag, or Au. When using Sn, it is possible to achieve the effects as described above.

Meanwhile, FIGS. 5a to 5c show a structure which is provided with the internal layer and the upper and lower external layers. However, the present invention may provide another structure which is provided with an internal layer and a plurality of external layers. In this case, it is possible to form via posts on both sides of the external layers.

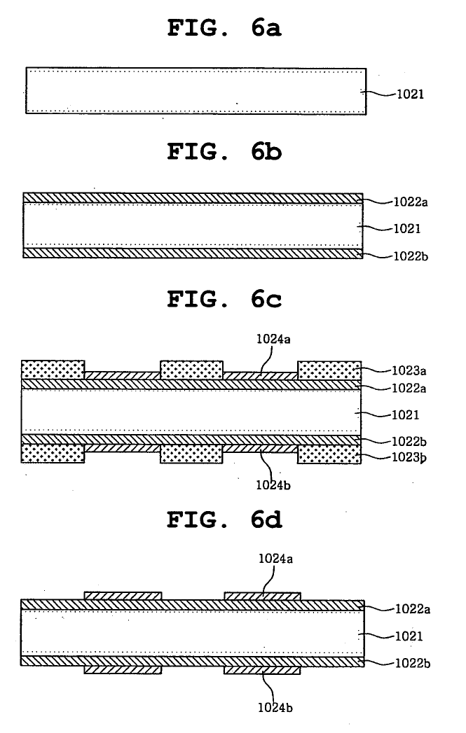

FIGS. 6a to 9 illustrate the method of fabricating the parallel MLB according to the present invention.

FIGS. 6a to 6h are sectional views illustrating the fabrication of a circuit layer through a semi-additive process in the method of fabricating the parallel MLB according to the present invention.

With reference to FIG. 6a, in order to fabricate a high density substrate through the semi-additive process, a rigid substrate 1021 is prepared as a base substrate.

Referring to FIG. 6b, the base substrate is subjected to an electroless copper plating process to form thin seed layers 1022a, 1022b.

Referring to FIG. 6c, after photosensitive resists 1023a, 1023b are laminated on the thin seed layers 1022a, 1022b, which are formed through the electroless copper plating process, exposure and development are conducted to form a circuit pattern, and electrolytic copper plating layers 1024a, 1024b are then formed on the thin seed layers 1022a, 1022b, which are formed through the electroless copper plating process.

Subsequently, referring to FIG. 6d, after the electrolytic copper plating layers 1024a, 1024b are formed on the thin seed layers 1022a, 1022b, which are formed through the electroless copper plating process, the photosensitive resists 1023a, 1023b are removed.

Next, referring to FIG. 6e, after a photosensitive resist 1025 is laminated on a lower electrolytic copper plating layer 1022b of the base substrate 1021, exposure and development are implemented to form a circuit pattern to form via posts 1030.

Referring to FIG. 6f, an electrolytic plating process is conducted using Cu or Ag so as to form the via posts 1030 on the circuit pattern of the photosensitive resist 1025, thereby forming support parts 1026. Another electrolytic plating process is conducted using Sn to form connection parts 1027.

Next, referring to FIG. 6g, the photosensitive resist 1025, on which the circuit pattern for forming the via posts 1030 is formed, is removed.

Next, referring to FIG. 6h, a flash etching process is implemented to remove the seed layers 1022a, 1022b from both sides of the base substrate 1021.

Meanwhile, FIGS. 6a to 6h show the formation only of an upper external layer of the parallel MLB according to the present invention, but a lower external layer may also be formed through the same procedure as the upper external layer.

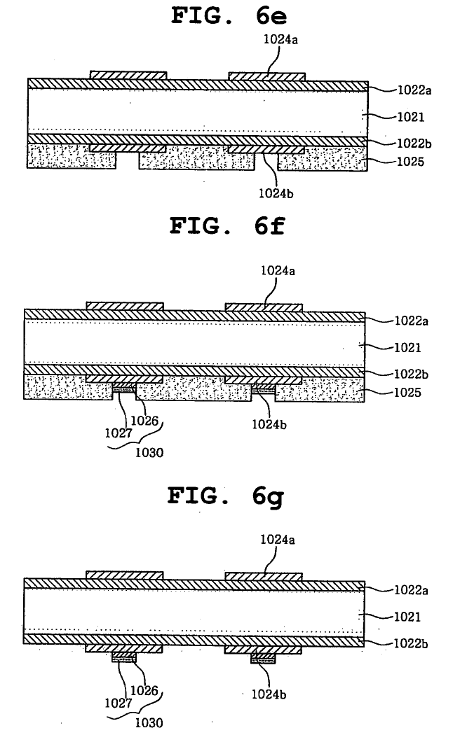

FIGS. 7a to 7c are sectional views illustrating the fabrication of a connection layer in the method of fabricating the parallel MLB according to an embodiment of the present invention.

Referring to FIG. 7a, a substrate 1000 for the connection layer is provided with a thermosetting resin layer 1010 and release films 1012 attached to both sides of the thermosetting resin layer.

The thickness of the thermosetting resin layer 1010 depends on the specification of the product, and each of the release films 1012 is 20-30 μm in thickness. The release films may be attached to the thermosetting resin layer during the fabrication of the thermosetting resin layer 1010, or may be attached through a separate process.

In FIG. 7b, the substrate 1000 for the connection layer is drilled to form through holes 1014 therethrough. The through holes 1014 may be formed through a mechanical drilling process, but a laser drill is used in order to form fine through holes.

In FIG. 7c, after the through holes 1014 are formed through the substrate 1000 for the connection layer, the release films 1012 are removed.

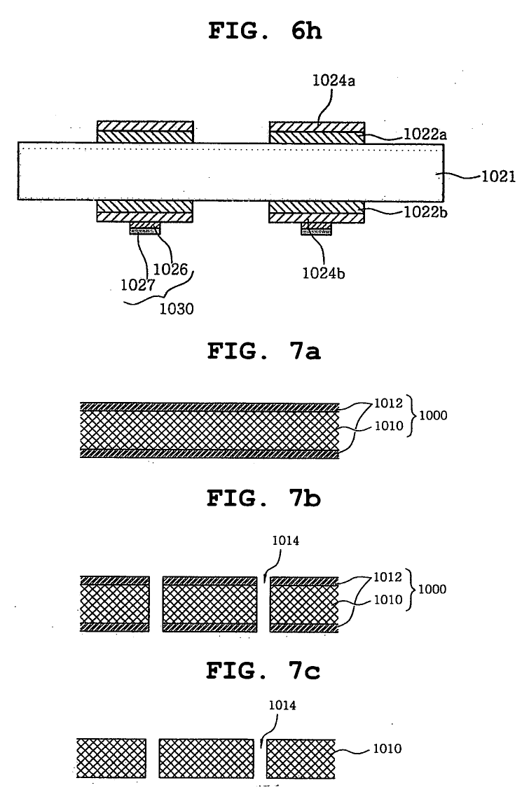

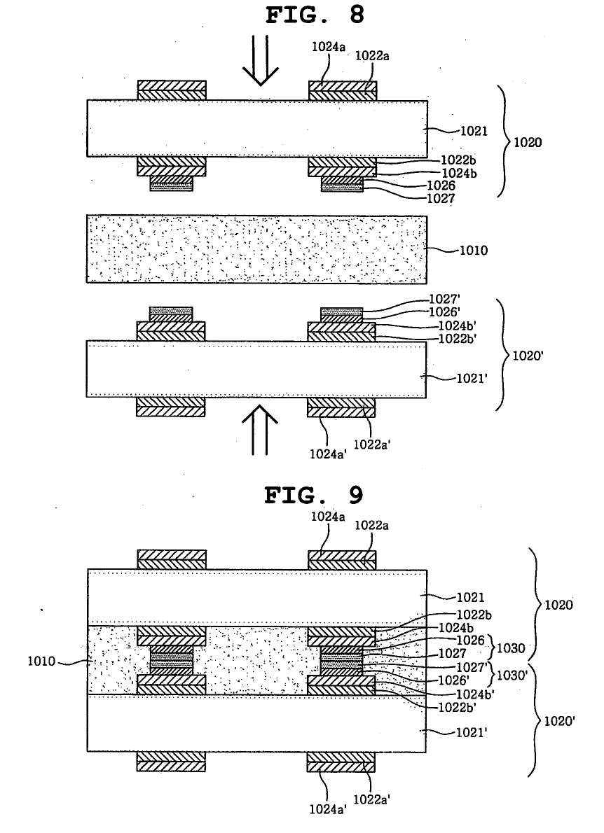

FIG. 8 illustrates an alternate arrangement of the circuit layer and the connection layer in the method of fabricating the parallel MLB according to an embodiment of the present invention, and FIG. 9 is a sectional view of the MLB according to an embodiment of the present invention, which is fabricated by pressing the layers of FIG. 8.

With reference to FIG. 8, the external layers 1020, 1020′, which are fabricated through the procedure of FIGS. 6a to 6g, and the internal layer 1010, which is fabricated through the procedure of FIGS. 7a to 7c, are arranged.

The layers are aligned in a targeting or pin manner so that the via posts 1030, 1030′ of the external layers 1020, 1020′ precisely match the through holes of the internal layer 1010.

In the targeting manner, a target hole is formed through a ‘target guide mark’ of the internal layer, which is a reference point in a drilling process, and X-rays are used as a target drill.

According to the pin manner, holes as a reference for interlayer alignment are formed at the same position during a drilling process, and a pin is inserted into the holes of circuit and insulating layers during a layering process, thereby aligning the circuit and insulating layers.

Subsequently, the internal and external layers are pressed using a press in the direction of the arrow in FIG. 8, thereby creating the MLB as shown in FIG. 9.

A ‘hot press’ is frequently used to convert the laminated layers into one PCB. At this stage, the lamination is conducted in such a way that the laminated layers are put into a case and then pressed/heated using a vacuum chamber which includes hot plates installed at upper and lower parts thereof. This is called a vacuum hydraulic lamination (VHL) method.

In addition, a vacuum press may be used. With respect to this, an electric heater is provided to a vacuum chamber as a heating source, and the lamination is then conducted in a pressurized state using gas. This is advantageous in that since it is unnecessary to use the hot plate, the lamination is achieved regardless of the number of layers, in other words, the lamination is achieved at one time even if the number of layers is 6, 8, or 10 layers. Therefore, it has an advantage over small-scaled production.

Meanwhile, when the external and internal layers are pressed through a press process, a prepreg constituting the internal layer 1010 has a melting point that is lower than that of the connection parts 1027. Accordingly, when the external and internal layers are pressed through the press process, the prepreg is melted and then packed in spaces (the spaces are created because the radii of the via posts 1030, 1030′ are smaller than those of the through holes) of the through holes of the internal layer 1010. Subsequently, Sn of the connection parts 1027, 1027′ of the external layers 1020, 1020′ is melted, thereby realizing physical and electrical connections between the connection parts 1027, 1027′.

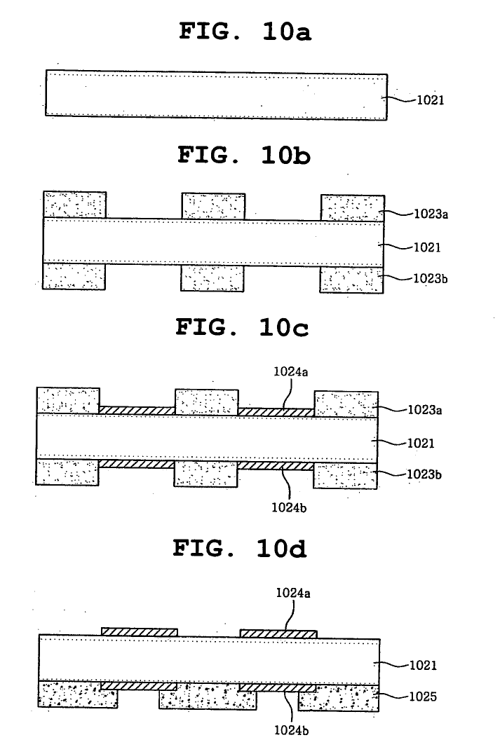

FIGS. 10a to 10f are sectional views illustrating the fabrication of a circuit layer through a full-additive process in a method of fabricating a parallel MLB according to another embodiment of the present invention.

Referring to FIG. 10a, an insulating resin 1021 is prepared as a base substrate in the course of fabricating the circuit layer through the full-additive process.

Referring to FIG. 10b, photosensitive resists 1023a, 1023b are attached to the insulating resin 1021, and patterned by exposure and development.

Subsequently, referring to FIG. 10c, after circuit patterns are formed by the photosensitive resists 1023a, 1023b, an electroless copper plating process is conducted to form electroless copper plating layers 1024a, 1024b.

Next, referring to FIG. 10d, the photosensitive resists 1023a, 1023b are removed, a photosensitive resist 1025 is laminated to form via posts 1030 on the lower electroless copper plating layers 1024b of the base substrate 1021, and exposure and development are conducted to form a circuit pattern thus allowing the via posts 1030 to be formed therethrough.

Referring to FIG. 10e, an electrolytic plating process is conducted using Cu, Ag, or Au to form the via posts 1030 on the circuit pattern of the photosensitive resist 1025, thereby forming supports parts 1026. Another electrolytic plating process is conducted using Sn to form connection parts 1027.

Referring to FIG. 10f, the photosensitive resist 1025, on which the circuit pattern for forming the via posts 1030 is formed, is removed.

Meanwhile, FIGS. 10a to 10f show the formation only of an upper external layer of the parallel MLB according to the aforementioned embodiment of the present invention, but a lower external layer may also be formed through the same procedure as the upper external layer.

Furthermore, FIGS. 7a to 7c illustrate the fabrication of the connection layer in the method of fabricating the parallel MLB according to an embodiment of the present invention, and this procedure of fabricating the connection layer may be applied to the fabrication of the parallel MLB according to any of the above embodiments of the present invention.

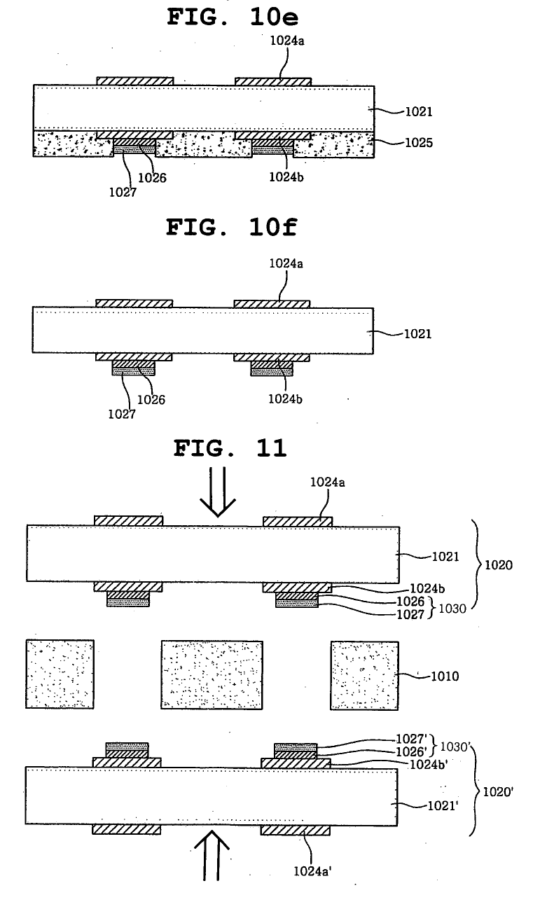

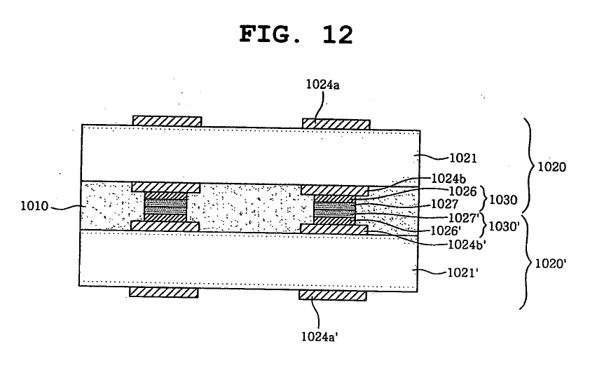

FIG. 11 illustrates the alternate arrangement of the circuit layer and the connection layer in the method of fabricating the parallel MLB according to the second embodiment of the present invention, and FIG. 12 is a sectional view of the MLB according to the embodiment in FIG. 10 of the present invention, which is fabricated by pressing the layers of FIG. 11.

With reference to FIG. 11, the external layers 1020, 1020′, which are fabricated through the procedure of FIGS. 10a to 10f, and the internal layer 1010, which is fabricated through the procedure of FIGS. 7a to 7c, are arranged.

The layers are aligned in a targeting or pin manner so that the via posts 1030, 1030′ of the external layers 1020, 1020′ precisely match the through holes of the internal layer 1010.

Subsequently, the internal and external layers are pressed using a press in the direction of the arrow in FIG. 11, thereby creating the MLB as shown in FIG. 12.

Meanwhile, the present embodiment shows a structure in which the external layers 1020, 1020′ do not have the via holes, but the present invention may be applied to another structure in which the external layers have via holes.

The fabrication of the PCB according to yet another embodiment of the present invention is different from those according to any of the previous embodiments in that a single layer structure is formed instead of a two layer structure of support and connection parts in the course of forming the via posts. Those skilled in the art may easily realize this embodiment referring to the present invention.

Additionally, with respect to the formation of the circuit layer, the present invention discloses only semi-additive and full-additive processes, but a subtractive process may also be employed to form the circuit layer.

A parallel MLB, which has interlayer conductivity due to a via post, and a method of fabricating the same according to the present invention have been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced other than as specifically described.

In a method of fabricating a conventional parallel MLB, when connection layers are connected to each other, since a mechanical or laser drill is employed, the size of a via post is 100 μm or more. However, the present invention is advantageous in that since a via post is formed using circuit and plating processes, it is possible to form the via post having a size of 30 μm or less if the circuit process is desirably conducted.

Another advantage of the present invention is that when an end of the via post is plated with Sn, alignment is effectively achieved using a self-alignment property during the application of a flip chip bump.

Still another advantage of the present invention is that since a package lamination process is used even though it is possible to realize the MLB of the present invention through a build-up process, fabrication time is reduced.

Yet another advantage of the present invention is that the connection is achieved using Sn plating instead of a conventional package lamination process, in which a costly paste is applied to the connection layer, thereby reducing the fabrication cost.

What is claimed is:

1. A parallel multilayer printed circuit board (MLB), which has interlayer conductivity due to via posts, comprising:
insulating layers through which a plurality of through holes are formed; and
a pair of circuit layers which are laminated on both sides of the insulating layers, and which have the via posts, made of a conductive material, protruding therefrom, the via posts being formed at positions corresponding to the through holes of the insulating layers such that the via posts come into contact with each other to provide interlayer connection.

2. The parallel MLB as set forth in claim 1, wherein each of the via posts of the circuit layers comprises:
a connection part which is made of the conductive material and which comes into contact with a corresponding adjacent via post; and
a support part which supports the connection part and which electrically connects the connection part to a circuit pattern of each of the circuit layers.

3. The parallel MLB as set forth in claim 2, wherein the connection part includes an Sn layer.

4. The parallel MLB as set forth in claim 2, wherein the connection part includes a conductive paste.

5. The parallel MLB as set forth in claim 1, wherein the via posts of the circuit layers, which correspond to each other, come into contact with each other, and include a Sn layer.

6. The parallel MLB as set forth in claim 1, wherein the via posts of the circuit layers, which correspond to each other, come into contact with each other, and include a conductive paste layer.

7. A method of fabricating a parallel multilayer printed circuit board having interlayer conductivity due to via posts, comprising the steps of:
forming a plurality of through holes through an insulating layer;
forming circuit layers on both sides of each of a pair of base substrates;
forming via posts on the circuit layers of the pair of base substrates such that the via posts correspond in position to the through holes of the insulating layer, wherein the circuit layers are to be laminated on the insulating layer to come into contact therewith; and
aligning the pair of base substrates in such a way that the insulating layer is interposed between the base substrates so that the via posts are positioned in the through holes of the insulating layer, and heating and pressing a resulting structure to cause the via posts, facing each other, to come into contact with each other.

8. The method as set forth in claim 7, wherein the step of forming circuit layers on both sides of each of a pair of base substrates comprises the steps of:
electroless copper plating both sides of each of the pair of base substrates to form thin seed layers;
laminating photosensitive resists on the seed layers, patterning the photosensitive resists, and forming circuit patterns through exposure and development processes; and
forming electrolytic copper plating layers on the circuit patterns, which are formed by the photosensitive resists, to form the circuit layers.

9. The method as set forth in claim 7, wherein the step of forming circuit layers on both sides of each of a pair of base substrates comprises the steps of:
attaching photosensitive resists to the base substrates, and forming circuit patterns through exposure and development processes;
electroless copper plating the circuit patterns, wherein the circuit patterns are formed by the photosensitive resists, to form electroless copper plating layers, thereby forming the circuit layers; and
removing the photosensitive resists after the circuit layers are formed on the base substrates.

10. The method as set forth in claim 7, wherein the step of forming via posts on the circuit layers of the pair of base substrates comprises the steps of:
laminating photosensitive resists on the circuit layers of the pair of base substrates, which are to be laminated on the insulating layer to come into contact therewith, and conducting exposure and development processes to remove portions of the photosensitive resists, which correspond in position to the via posts to be formed;
forming the via posts in openings of the photosensitive resists, which are formed by removing the portions of the photosensitive resists; and
removing the photosensitive resists.

11. The method as set forth in claim 10, wherein the formation of the via posts is conducted in such a way that the openings of the photosensitive resists are subjected to an electrolytic plating process.

12. The method as set forth in claim 10, wherein the formation of the via posts comprises the steps of:
electrolytic plating the openings of the photosensitive resists to form support parts; and
electrolytic plating the support parts to form connection parts.

13. The method as set forth in claim 10, wherein the formation of the via posts comprises:
electrolytic plating the openings of the photosensitive resists to form support parts; and
applying a conductive paste onto the support parts to form connection parts.
